(19) United States
(12) Patent Application Publication
(10) Pub. No.: US 2022/0198084 A1
(43) Pub. Date: Jun. 23, 2022

(54) SOLAR PANEL PLACEMENT SYSTEMS AND METHODS

(71) Applicant: Loveland Innovations, Inc., Pleasant Grove, UT (US)

(72) Inventors: Jim Loveland, Alpine, UT (US); Leif Larson, Orem, UT (US); Dan Christiansen, Orem, UT (US); Tad Christiansen, Lehi, UT (US); Daniel Gerszewski, Lehi, UT (US)

(21) Appl. No.: 17/557,809

(22) Filed: Dec. 21, 2021

Related U.S. Application Data
(60) Provisional application No. 63/128,345, filed on Dec. 21, 2020.

(51) Int. Cl. G06F 30/13; G06F 3/04815; G06F 3/04847

(52) U.S. Cl. CPC G06F 30/13; G06F 3/04847; G06F 3/04815

(57) ABSTRACT

A solar panel placement system models the location of one or more solar panels in one or more groupings, rows, or columns on a roof of a structure. The solar panel placement system may generate a graphical user interface to present one or more possible solar panel arrangements on the roof of the structure that attain a target parameter and conform to one or more user-provided or system-default solar panel parameters, solar array parameters, and/or aesthetic parameters.

### RELATED APPLICATIONS

This application claims benefit of and priority to U.S. Provisional Patent Application No. 63/128,345, filed on Dec. 21, 2020, titled “Solar Panel Placement Systems and Methods,” which application is hereby incorporated by reference in its entirety. This application is also related to U.S. patent application Ser. No. 17/453,152, filed on Nov. 1, 2021 titled “Graphical User Interface for Controlling a Solar Ray Mapping;” U.S. patent application Ser. No. 16/865,158, filed on May 1, 2020, titled “Image Analysis and Estimation of Rooftop Solar Exposure Via Solar Ray Mapping;” U.S. Provisional Patent Application No. 62/842,961, filed on May 3, 2019, titled “Image Analysis and Estimation of Rooftop Solar Exposure;” U.S. patent application Ser. No. 16/522,948, filed on Jul. 26, 2019, also titled “Image Analysis and Estimation of Rooftop Solar Exposure;” U.S. patent application Ser. No. 16/228,019, filed on Dec. 20, 2018, titled “Image Analysis and Estimation of Rooftop Solar Exposure;” and U.S. Provisional Patent Application No. 62/722,714, filed on Aug. 24, 2018, titled “Systems and Methods for Imaging and Reporting the Solar Irradiance of a Structure,” each of which is hereby incorporated by reference in its entirety.

### TECHNICAL FIELD

This disclosure relates to systems and methods for determining spatial and temporal solar irradiance values of a roof of a structure.

### BRIEF DESCRIPTION OF THE DRAWINGS

Non-limiting and non-exhaustive embodiments of the disclosure are described herein, including various embodiments of the disclosure with reference to the figures listed below.

FIG. 1 illustrates a graphical user interface with a spatial heatmap representing solar irradiance values on a roof of a structure, according to one embodiment.

FIG. 2 illustrates an overlay recommendation of solar panel placement based on temporally averaged solar irradiance values calculated for a roof of a particular structure, according to one embodiment.

FIG. 3 illustrates an example of a graphical user interface of a system enabling an operator to select sizes, quantities, power, and/or prices of a plurality of solar panels for installation, according to one embodiment.

FIG. 4 illustrates an example of an overlay recommendation of solar panel placement based on temporally averaged solar irradiance values and user-specified solar power system specifications, according to one embodiment.

FIG. 5A illustrates an example of a solar panel placement system modeling the placement of a solar panel on a roof of a three-dimensional model of a structure, according to one embodiment.

FIG. 5B illustrates the incremental addition of a second solar panel to form an array of solar panels on the roof of the three-dimensional model of the structure, according to one embodiment.

FIG. 5C illustrates the solar panel placement system determining a maximum number of solar panels that can be accommodated on a bottom row of the portion of the roof of the three-dimensional model of the structure, according to one embodiment.

FIG. 5D illustrates the solar panel placement system identifying the maximum number of solar panels that can be accommodated on the penultimate row of the portion of the roof of the three-dimensional model of the structure, according to one embodiment.

FIG. 5E illustrates a possible arrangement with the penultimate row shifted to account for a user specification that staggered panels are not allowed, according to one embodiment.

FIG. 5F illustrates the solar panel placement system identifying the maximum number of solar panels that can be accommodated on the portion of the roof as determined by incremental addition of panels to each row starting from the left, according to one embodiment.

FIG. 5G illustrates the solar panel placement system shifting each row of panels to the center based on a user-specified horizontal justification preference, according to one embodiment.

FIG. 6A illustrates the solar panel placement system identifying, on a graphical user interface, a possible arrangement of 30 300-Watt solar panels to attain a target output power of 9 kW, according to one embodiment.

FIG. 6B illustrates the solar panel placement system identifying an alternative arrangement of 30 300-Watt solar panels to attain a target output power of 9 kW, according to one embodiment.

FIG. 6C illustrates the solar panel placement system identifying another alternative arrangement of 30 300-Watt solar panels to attain a target output power of 9 kW, according to one embodiment.

FIG. 6D illustrates the solar panel placement system identifying an arrangement of 30 300-Watt solar panels based on the arrangement in FIG. 6C with a centered grouping preference activated, according to one embodiment.

FIG. 7A illustrates an example of a solar panel placement system modeling the placement of a 3×3 solar panel group on a roof of a three-dimensional model of a structure, according to one embodiment.

FIG. 7B illustrates an example of the solar panel placement system identifying the maximum number of 3×3 solar panel groups that can fit on each row of 3×3 solar panel groups on the roof of the three-dimensional model of the structure, according to one embodiment.

FIG. 7C illustrates the solar panel placement system shifting each row of 3×3 solar panel groups based on a user-specified horizontal justification preference, according to one embodiment.

FIG. 8A illustrates an example of a solar panel placement system identifying the maximum number of solar panels that can be accommodated on a roof of a structure with an overlaid heatmap of solar irradiance, according to one embodiment.

FIG. 8B illustrates an example of a solar panel placement system identifying the most efficient locations for solar panels with a minimum group size of 1 that can be used to generate the target output power, according to one embodiment.

FIG. 8C illustrates an example of a solar panel placement system identifying the most efficient locations for solar panels with a minimum group size of 3 that can be used to generate the target output power, according to one embodiment.

FIG. 9 illustrates a solar panel placement system, according to one embodiment.

### DETAILED DESCRIPTION

According to various embodiments, a solar panel placement system models the location of one or more solar panels in one or more groupings, rows, or columns on the roof of a structure. The solar panel placement system may generate a graphical user interface (commonly referred to as a “GUI”) to present one or more possible solar panel arrangements on the roof of the structure that attain a target parameter and conform to one or more user-provided or system-default solar panel parameters, solar array parameters, and/or aesthetic parameters. In some embodiments, the solar panel placement system may further consider solar irradiance values associated with locations on the roof of the structure.

According to various embodiments, a solar panel placement system may acquire information identifying an estimate of annual solar irradiance (e.g., measured in cumulative kWh/m²) on a roof, or a portion of a roof, of a structure. In some embodiments, a graphical user interface may display a context-rich visualization of the annual solar irradiation associated with the selected target location. In some embodiments, the solar panel placement system may receive or generate a detailed finite element model, or heatmap, of the solar irradiance. For example, a visual display of portions of the roof with the highest solar irradiance or highest average solar irradiance may be displayed as an overlay on the roof using a blackbody radiation color mapping, or other color or grayscale mapping. The solar panel placement system may receive or calculate the solar irradiance for one or more portions of the roof for positioning one or more solar panels or one or more arrays of solar panels on each of the one or more portions of the roof.

According to various examples, obstacles, such as trees, chimneys, vents, air conditioning units, swamp coolers, satellite receivers, and the like, may block sunlight from hitting some locations on the roof at some times during the day and on some days of the year. The same tree may block different portions of the roof at different times of the day and/or on different days of the year. A graphical user interface may show a heatmap that uses various shades of gray or different colors (e.g., blackbody temperature modeling) to illustrate the relative impact or effect of various obstacles and obstructions. White or red may be used to show unshaded portions of the roof. Darker gray shading or darker shades of blue may be used to show the impact or effect of shadows on the roof that have a significant or relatively higher light-blocking effect over a period of time. Lighter gray shading or various shades of red (or another color) may be used to show the impact or effect of shadows cast by obstacles that have less of an overall light-blocking effect over a period of time.

A solar evaluation system may determine (e.g., calculate or receive from a third-party system) the total irradiance at a target location (e.g., one face of a roof on which solar panels are to be placed). For example, the solar panel placement system or a connected independent system may use historical data (e.g., known angles and locations of the sun day-by-day, expected number of sunny days and cloudy days, etc.) to determine the total solar irradiance expected at the target location for one year (or another period of time). In some embodiments, it may be useful to calculate a first solar irradiance value during hot months when air conditioners are in use and calculate a second solar irradiance value in colder months when electrical usage is lower.

According to various embodiments, the solar panel placement system may utilize various user inputs to determine a solar panel layout. User-specified goals or target values for daily, monthly, or annual solar collection may be used to determine the number of panels needed and an optimized or partially optimized placement for the panels one or more portions of the roof of a structure. In various embodiments, the system may provide solar layout design specifications that include the total number of panels, the number of panels connected in series, the number of panels connected in parallel, the gauge of wire needed, the number of branch connectors, the number of maximum power point tracking (MPPT) or other types of controllers, the number of inverters, the number of batteries, the number of transfer switches, etc. Cost estimates may be provided and illustrated as part of the graphical user interface for the complete solar array system and/or for portions thereof.

As described herein, a user may specify one or more parameters, including solar panel parameters and solar array parameters, that are used by the solar panel placement system to identify possible solar panel layouts. Examples of possible solar panel parameters include, but are not limited to, a brand, dimensions, maximum power output, open circuit voltage, maximum power point voltage, short circuit current, maximum power point current, maximum system voltage for panels in series, and the like. Examples of possible solar array parameters include, but are not limited to, a minimum group size, allowed panel orientations, maximum angle relative to the roof, minimum total power, maximum total power, target total power, and the like.

In some embodiments, for aesthetic reasons, to conform to local ordinances, in accordance with industry best practices, or for other reasons, the user may provide and/or the system may include default settings specifying one or more of the aesthetic parameters. In some instances, some of the solar panel parameters and/or the solar array parameters may also be considered or be categorized as an aesthetic parameter. An example of an aesthetic parameter is a maximum angle that solar panels may be positioned relative to the slope of the roof (e.g., 0 degrees, 5 degrees, 15 degrees, etc.). Other aesthetic parameters may establish minimum grouping sizes, ascending or descending numbers of panels in each row of a solar panel array, maximum spacing between groups of solar panels, colors of solar panel frames, colors of solar panel glass, a maximum allowed reflectivity of solar panels at specific angles or ranges of angles, rules for centering each grouping of panels or the entire array of panels vertically and/or horizontally on a portion of a roof, minimum panel size to be used, allowing or prohibiting of staggered panels, etc.

In one embodiment, a user may toggle a box for acceptable sizes of the solar panels. For example, the operator may select a panel type from a drop-down menu or select specific panel sizes that are available (e.g., 2′×4′, 3′×5′, etc., or other size panels including non-rectangular shapes). In some embodiments, a user may select all available panel sizes and allow the system to return the best design to capture the highest level of solar exposure, highest level of solar exposure within financial constraints (e.g., a break-even or profitability goal), and/or cheapest design that meets minimum requirements.

In some embodiments, the solar panel placement system may recommend an angle of the panels relative to the roof and/or account for and recommend solar-tracking solar panel mounts (i.e., mechanically rotating solar panel mounts). In some embodiments, a user may specify limitations for aesthetic reasons. For instance, a user may want only low-profile solar panels and/or prefer to avoid solar tracking mounts. In some embodiments, a user may specify a specific color of solar panel (e.g., blue or black tints) and/or frame colors. The solar panel placement system may perform calculations for stored brands and models of solar panels meeting the user's specifications. In some embodiments, the user may specify different aesthetic parameters for different faces or portions of the roof. For example, the user may be less concerned with the aesthetics of a solar panel array on the back of a house as compared to the sides and/or front of the house.

According to various embodiments, the solar panel placement system may determine how many panels or groups of panels may fit on a portion of a roof by iteratively placing, shifting, moving, and adding a panel or group of panels to a three-dimensional model of a portion of a roof. In some embodiments, the solar panel placement system may provide one or more options of the “best” or optimally placed number of solar panels to attain a target goal. For example, the solar panel placement system may identify the maximum number of panels that can fit on a portion of a roof, the maximum power output that can be achieved on a portion of a roof, options for positioning a specific number of panels on a portion of a roof, options for positioning a specific grouping or arrangement of panels on a portion of a roof, and/or other options for positioning solar panels based on user selections, user inputs, and/or default settings of the solar panel placement system.

In some embodiments, the solar panel placement system may output one or more options for a number of solar panels and locations for positioning the number of solar panels to attain a target output power at the lowest cost. For example, the solar panel placement system may identify three different arrangements of 15 200-Watt solar panels to attain a maximum output power of 3 kW and two different arrangements of 10 300-Watt solar panels to attain the same maximum output power of 3 kW. Visual representations of the five different options of solar panel arrangements may be presented via a graphical user interface to facilitate a decision. In some embodiments, the solar panel placement system may present cost estimates associated with each of the different options. The cost estimates may be for the panels only, other associated components (e.g., inverters, wires, etc.), and/or installation cost estimates.

In some embodiments, the solar panel placement system may output one or more options for a number of solar panels (e.g., an array of solar panels with one or more groups of solar panels in rows and/or columns) and locations for positioning the number of solar panels in accordance with a specified solar array performance metric. Examples of possible solar array performance metrics include, but are not limited to, maximizing the power output, maximizing the total efficiency of the array of solar panels, minimizing the cost per total kW of the system, minimizing the cost per total kW of the system within a range of power outputs, maximizing the total efficiency of the array of solar panels while attaining a target total output, minimizing the total cost of the array of solar panels while attaining a target total output, and minimizing the total cost of the array of solar panels while attaining a minimum total output.

According to one embodiment, a solar panel placement system includes various modules, subsystems, or user input fields within a graphical user interface to determine or otherwise identify solar panel size parameters, alignment parameters, and/or array parameters. For example, a solar panel parameter module may identify solar panel parameters, such as solar panel size parameters (e.g., physical dimensions), voltage parameters, current parameters, power parameters, etc. An alignment module may identify solar panel alignment parameters, such as whether the panels are to be aligned with one another or staggered. An array parameter module may identify solar panel array parameters, such as total power requirements, minimum efficiency requirements, target power output during a defined time period (e.g., based on a heatmap of solar irradiance values, as described in the patent applications incorporated by reference above), target output during a future time period when shadows are expected to impact that roof in a different manner than the shadows are currently impacting the roof, etc.

According to various embodiments, a structure module may generate or retrieve a three-dimensional model of a structure with at least one planar roof surface. A solar panel modeling module, system, or subsystem may calculate positions for each solar panel to be placed on the planar roof surface based on the solar panel size parameters, the solar panel alignment parameters, and the solar panel array parameters, etc. The solar panel modeling module, system, or subsystem may render a three-dimensional model of the plurality of solar panels arranged on the planar roof surface of the three-dimensional model of the structure.

A display module may render a graphical user interface for display on an electronic display. The graphical user interface may include the rendered three-dimensional model of the plurality of solar panels arranged on the planar roof surface of the three-dimensional model of the structure. The graphical user interface may include a specifications menu section identifying the parameters used for placing the solar panels and/or allowing the user to modify the specifications and parameters. In some embodiments, the user may move the solar panels on the roof of the structure to “allowed” locations (e.g., within the boundaries of each planar roof section). As the user moves the solar panels and/or places or removes solar panels from the array of solar panels, the graphical user interface may provide an indication of the average total output power, minimum output power, maximum output power, overall efficiency of the array of solar panels, minimum efficiency of any given solar panel, or the like.

In some embodiments, the graphical user interface may render the solar panels with color overlays to indicate the quality, power output, efficiency, or other solar power output expectation based on the location of each solar panel. For example, a solar panel in a location expected to receive a high amount of sunlight might be rendered in green and a solar panel in a location expected to receive off-angle sunlight expected to reduce the overall output might be rendered yellow. Similarly, a solar panel significantly shadowed during some days or parts of the year may be rendered red. In some embodiments, the entire solar panel array may be rendered with an outline in a color indicating an overall quality, efficiency, or ability to attain a target output parameter. For example, an array of solar panels may be rendered with a green outline if the array of solar panels is expected to operate at an efficiency above a target threshold or be able to attain a target output power specified by the system or a user. The array may be outlined in yellow or red if the expected output is close to or below the target threshold.

In some embodiments, the system includes an irradiance calculation subsystem to calculate a solar irradiance value for each location on the roof of the structure. Various approaches for calculating solar irradiance values are described in the patent applications incorporated by reference above. The solar panel modeling system may calculate, shift, adjust, or otherwise position the plurality of solar panels to include a minimum number of solar panels necessary to satisfy a total power output parameter during a defined time period based on the calculated solar irradiance values. Alternatively, the solar panel modeling system may calculate, shift, adjust, or otherwise position the plurality of solar panels to include the maximum number of solar panels possible. In still other embodiments, the solar panel modeling system may calculate, shift, adjust, or otherwise position the plurality of solar panels to include the maximum number of solar panels that will operate above a target threshold efficiency or target power output level during a specified time period. As in other embodiments, a specified time period may be part of a day, a week, a month, multiple months, a year, or multiple years.

In some embodiments, the display module may render a heatmap of solar irradiance values as an overlay on the planar roof surface of the structure and as an overlay on the plurality of solar panels arranged thereon. In some embodiments, the solar panel alignment parameters include a minimum group size parameter defining a minimum number of solar panels to be included in a subgroup of the plurality of solar panels on the planar roof surface. In such embodiments, the solar panel modeling system may calculate the positions of the plurality of solar panels to include a minimum number of solar panels to satisfy the total power output parameter during a defined time period based on the calculated solar irradiance values, without violating the minimum group size parameter.

According to various embodiments, the systems and methods described herein may be implemented via instructions stored within a non-transitory computer-readable medium. The instructions may be functionally or actually organized in different modules and, when executed by a processor of a computing device, cause the computing device to perform the operations described herein. For example, a computing system may access an electronic database and/or receive user inputs to identify solar panel parameters, solar panel alignment parameters, solar panel array parameters, a three-dimensional model of a structure, group parameters, and the like. The instructions may render or otherwise generate a graphical user interface that includes a three-dimensional model of a plurality of solar panels arranged on a planar roof surface of the three-dimensional model of the structure.

In various examples, the solar panel placement system may include a non-transitory, computer-readable medium for storing instructions. The system may store the instructions in memory, and a processor may implement various modules to accomplish calculations and tasks performed by the system. Some of the infrastructure that can be used with embodiments disclosed herein is already available, such as general-purpose computers, computer programming tools and techniques, digital storage media, and communications networks. A computer may include a processor, such as a microprocessor, microcontroller, logic circuitry, or the like. The processor may include a special-purpose processing device, such as an ASIC, a PAL, a PLA, a PLD, a CPLD, a Field Programmable Gate Array (FPGA), or another customized or programmable device. The computer may also include a computer-readable storage device, such as non-volatile memory, static RAM, dynamic RAM, ROM, CD-ROM, disk, tape, magnetic memory, optical memory, flash memory, or another computer-readable storage medium.

Suitable networks for configuration and/or use, as described herein, include any of a wide variety of network infrastructures. A network may incorporate landlines, wireless communication, optical connections, various modulators, demodulators, small form-factor pluggable (SFP) transceivers, routers, hubs, switches, and/or other networking equipment. The network may include communications or networking software, such as software available from Novell, Microsoft, Artisoft, and other vendors, and may operate using TCP/IP, SPX, IPX, SONET, and other protocols over twisted pair, coaxial, or optical fiber cables, telephone lines, satellites, microwave relays, modulated AC power lines, physical media transfer, wireless radio links, and/or other data transmission “wires.” The network may encompass smaller networks and/or be connectable to other networks through a gateway or similar mechanism.

Aspects of certain embodiments described herein may be implemented as software modules or components. As used herein, a software module or component may include any type of computer instruction or computer-executable code located within or on a computer-readable storage medium, such as a non-transitory, computer-readable medium. A software module may, for instance, comprise one or more physical or logical blocks of computer instructions, which may be organized as a routine, program, object, component, data structure, etc., that perform one or more tasks or implement particular data types, algorithms, and/or methods.

A particular software module may comprise disparate instructions stored in different locations of a computer-readable storage medium, which together implement the described functionality of the module. Indeed, a module may comprise a single instruction or many instructions and may be distributed over several different code segments, among different programs, and across several computer-readable storage media. Some embodiments may be practiced in a distributed computing environment where tasks are performed by a remote processing device linked through a communications network. In a distributed computing environment, software modules may be located in local and/or remote computer-readable storage media. In addition, data being tied or rendered together in a database record may be resident in the same computer-readable storage medium, or across several computer-readable storage media, and may be linked together in fields of a record in a database across a network.

The embodiments of the disclosure can be understood by reference to the drawings, wherein like parts are designated by like numerals throughout. The components of the disclosed embodiments, as generally described and illustrated in the figures herein, could be arranged and designed in a wide variety of different configurations. Further, those of skill in the art will recognize that one or more of the specific details may be omitted, or other methods, components, or materials may be used. In some cases, operations are not shown or described in detail. Thus, the following detailed description of the embodiments of the systems and methods of the disclosure is not intended to limit the scope of the disclosure, as claimed, but is merely representative of possible embodiments.

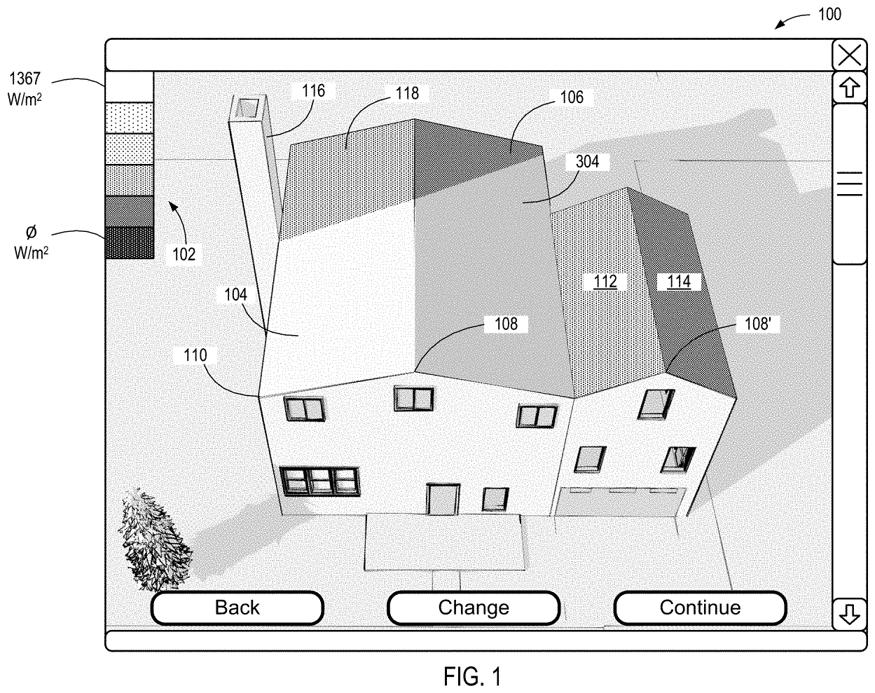

FIG. 1 illustrates a graphical user interface showing a three-dimensional model of a structure and surrounding area. The graphical user interface includes a heatmap 100 of the solar irradiance at various locations on a roof 110 of the structure. The heatmap 100 includes a legend 102 identifying white area 104 as corresponding to the area with the highest solar irradiance and dark area 106 as corresponding to the region with the lowest solar irradiance. The legend 102 also indicates that the heatmap 100 varies in solar irradiance from 1367 W/m² (e.g., at white area 104) in the most irradiant portions to zero W/m² or close to zero (e.g., at dark area 106) in the most obstructed portions. The system may round the irradiance down to zero for any region with insufficient light to activate a solar panel.

The graphical user interface also shows the effects of gables 108 and 108′ on the solar irradiance at various locations along roof 110. For example, the solar irradiance at a location along a section of roof 112 is slightly less than the solar irradiance at white area 104 due to the obstruction of gable 108. At a location along a section of roof 114, both gables 108 and 108′ may occlude solar exposure. Direct obstructions, such as chimney 116, may play an expanded role in the solar exposure throughout a day. Heatmap 100 allows for an averaged shadow 118 throughout the day. Thus, the averaged shadow 118 is shown having an area larger than the area of any actual shadow cast by chimney 116 at any point in time during the day.

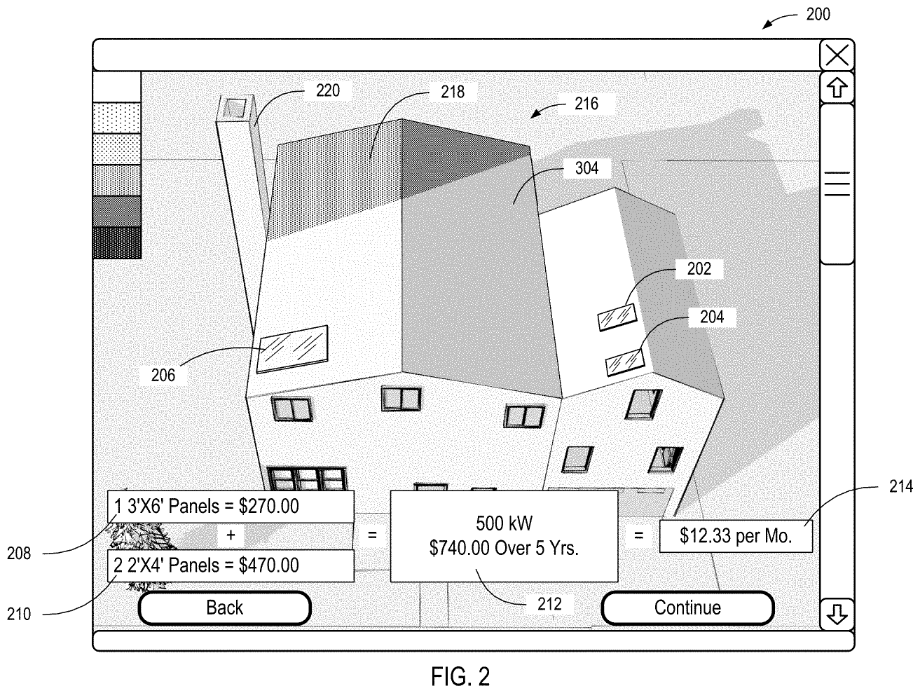

FIG. 2 illustrates a graphical user interface 200 of a solar panel placement system. The solar panel placement system may recommend locations 202, 204, and 206 for solar panels based on a user-input size of solar panels, e.g., inputs 208 and 210. The user inputs 208 and 210 may include the size and quantity of panels, the threshold limit 212 of the system, the cost per period 214 for the system, and/or other user-defined data. The solar panel placement system may recommend the placement of a particular size panel (e.g., 3′×6′ panel) in a specific location 206 on the roof. The solar panel placement system may recommend the placement 202, 204, and 206 of multiple panels. The system may generate a heatmap 216 and/or “stay-out” regions 218 for the panels based on one or more obstacles (e.g., chimney 220). The recommended placement of panels 202, 204, and 206 may depend on user inputs such as the cost, size, number, threshold limit 212, the cost per period 214, and/or other user inputs.

The heatmap 216 may represent an average solar distribution of irradiance for a period of time, such as a year. The system may base the estimated distribution of solar irradiance on historical irradiance data. For example, the system may use the solar irradiance of the past year (or an average of the last five, ten, twenty, or another number of years) to determine recommended panel sizes 208 and 210 and/or solar panel locations 202, 204, and 206. Heatmap 216 may provide a graphical recommendation of panel placement, as illustrated. Heatmap 216 may provide numerical irradiance data for the system to calculate panel placement.

For example, if the operator sets a 500-kW threshold limit over a period of five years (e.g., 100 kW/year), the system may generate a heatmap and recommend one or more suitable panel placements. The system may determine a quantity and location for solar panels to allow for a purchaser to fully offset an installation cost (e.g., based on saved electricity or electricity sold to another entity) within a prescribed time period (e.g., 7 years) at expected or current energy rates.

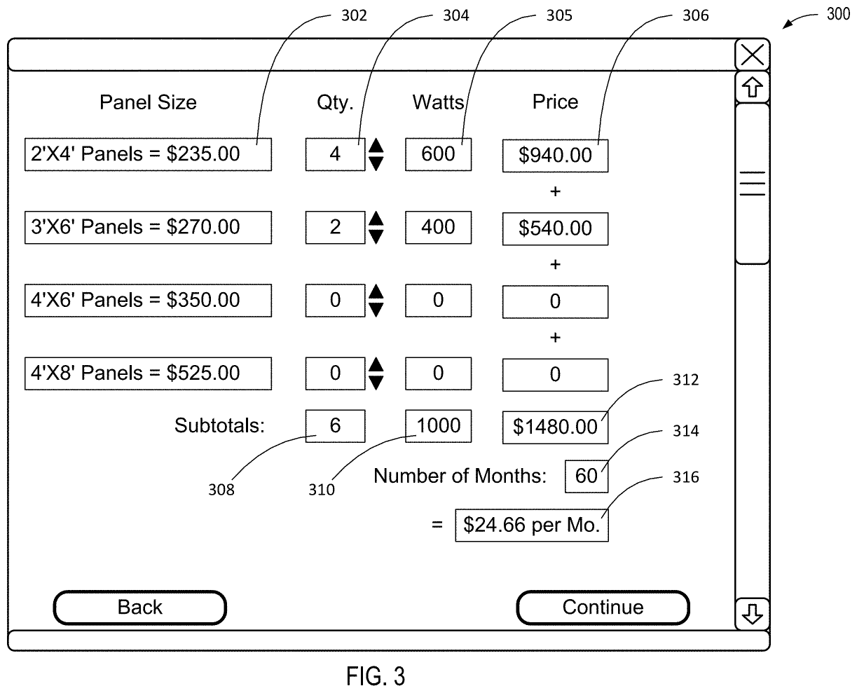

FIG. 3 illustrates an example of a graphical user interface 300 that allows the user to select a panel size 302 and quantity 304, and the system will generate the watts produced 305 and the price of the panels 306. For example, the operator may select a specific size panel 302 and a quantity 304 of each panel. The system may auto-populate the watts produced 305 and the price of the selected panels 306. In some embodiments, the operator may select all available panel sizes. This selection may permit the system to return a recommended optimal design to maximize solar exposure. The system may generate the quantity, size, price, and/or locations of the panels.

In some embodiments, the system may total the quantity of panels 308, the watts generated 310, and the total price 312. The user may input a desired payoff period 314, and the system may generate a cost per month 316. The system may additionally or alternatively generate and display a cost per kilowatt (kW), a cost per year, a lifetime savings, a lifetime cost, and/or other useful metrics.

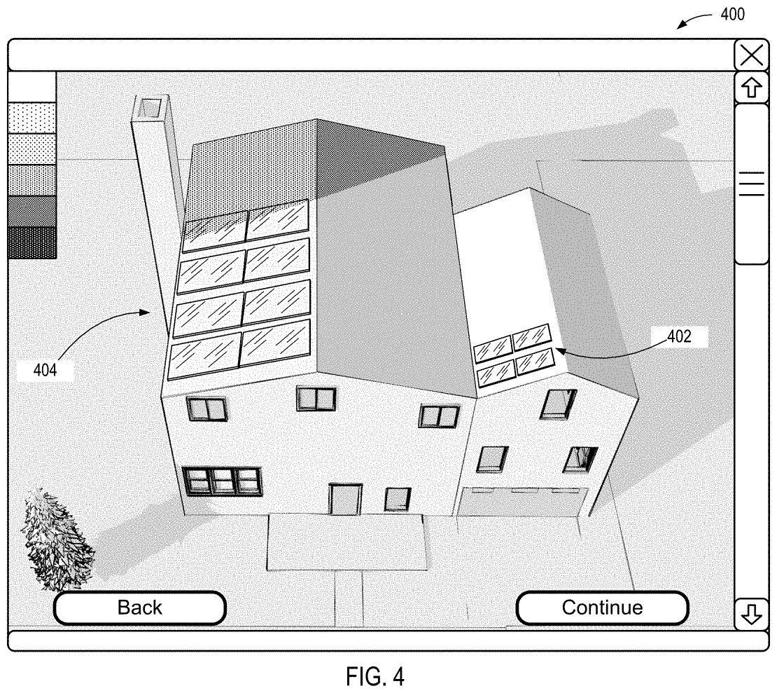

FIG. 4 illustrates a graphical user interface 400 for a solar placement system with the placement of panels of various sizes based on user input. The user may specify a total desired output, and the system may generate an optimized or suitable panel placement recommendation. Alternatively, the system may provide total output values, payoff values, estimated costs, etc., as an operator virtually places solar panels on the roof with the overlaid irradiation values (e.g., via a drag and drop operation) at locations 402 and 404. The system accounts for the decreased irradiance expected for solar panels placed within shadowed areas, as described herein.

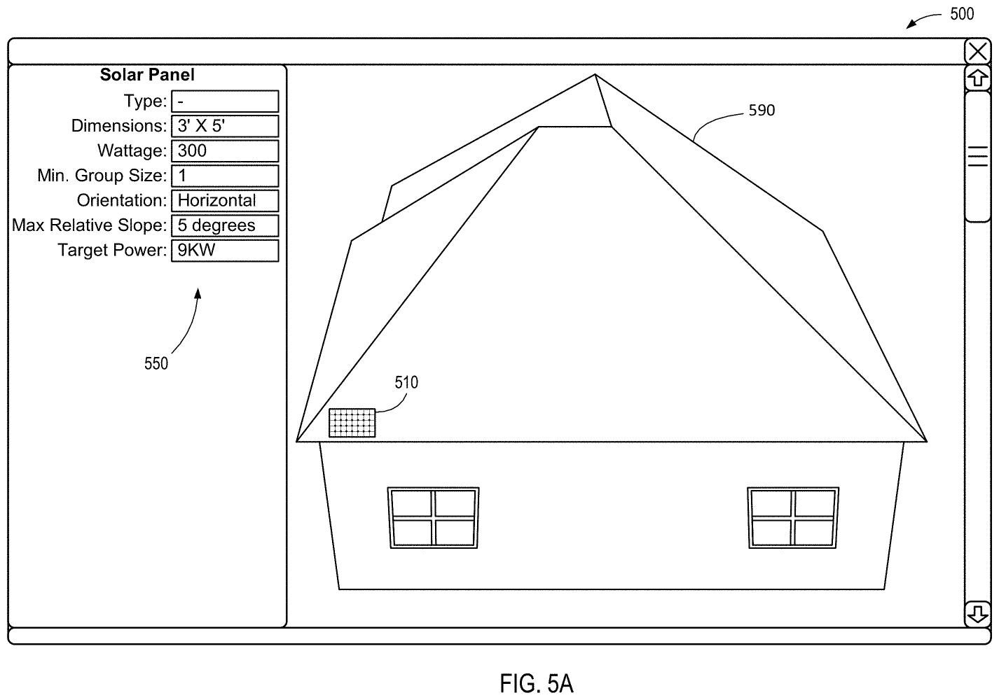

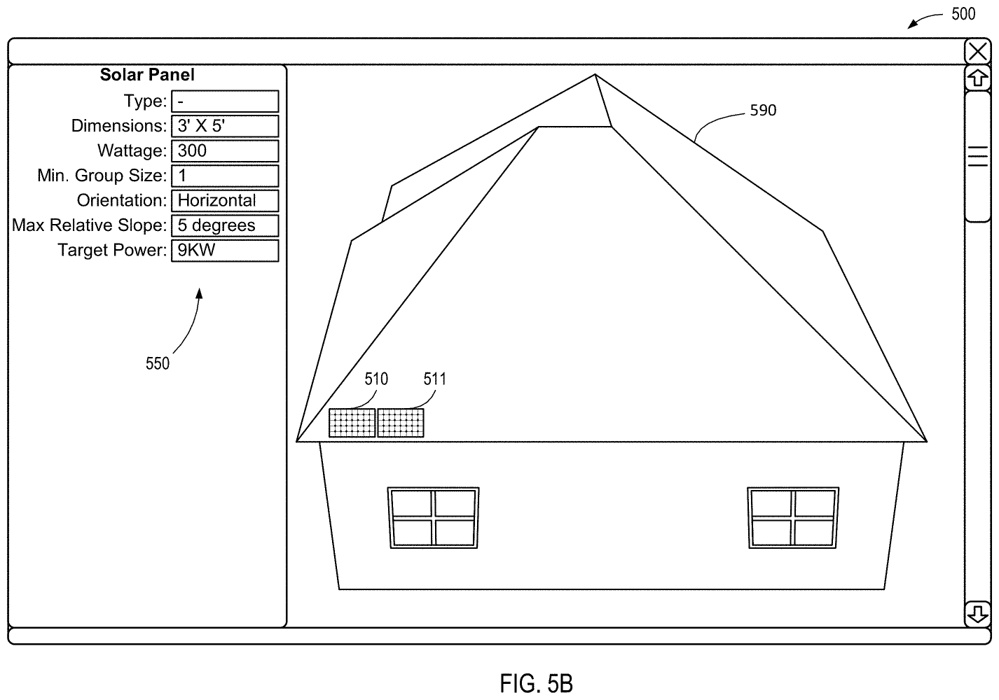

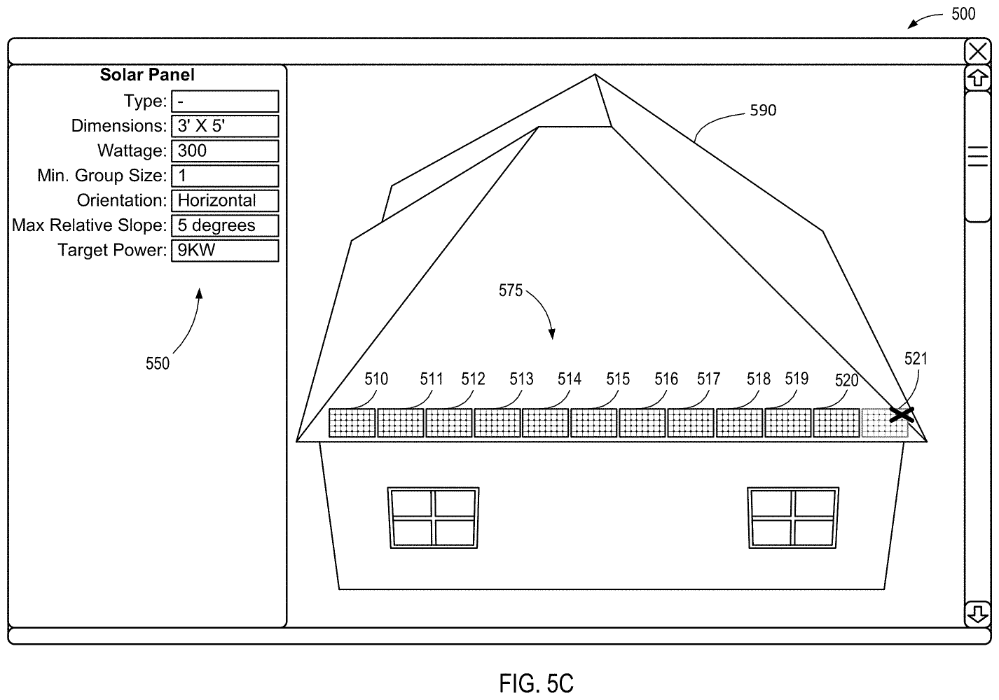

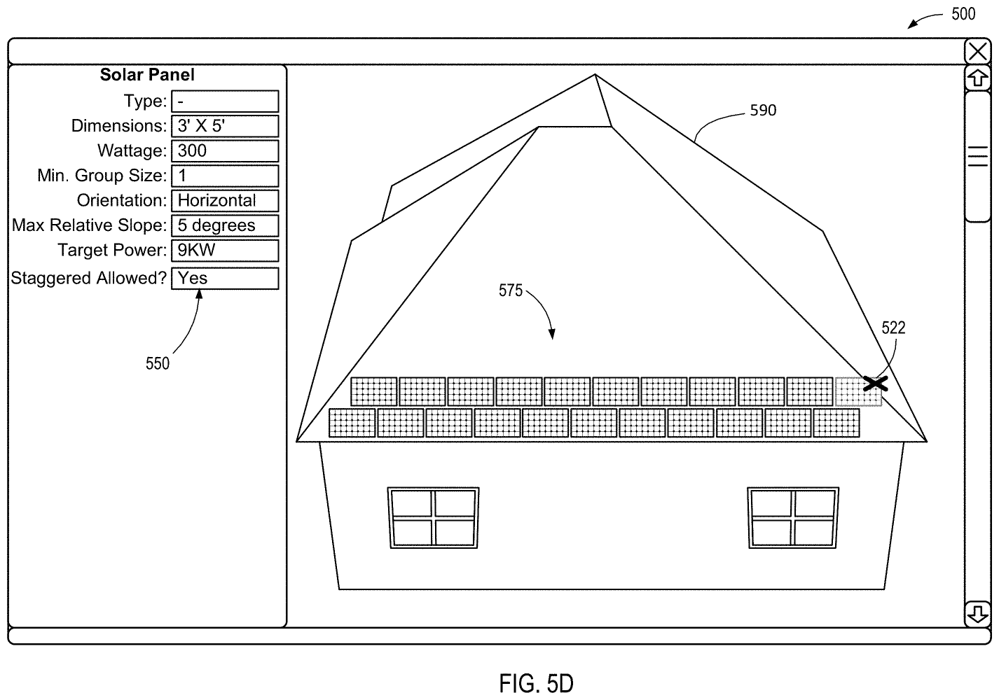

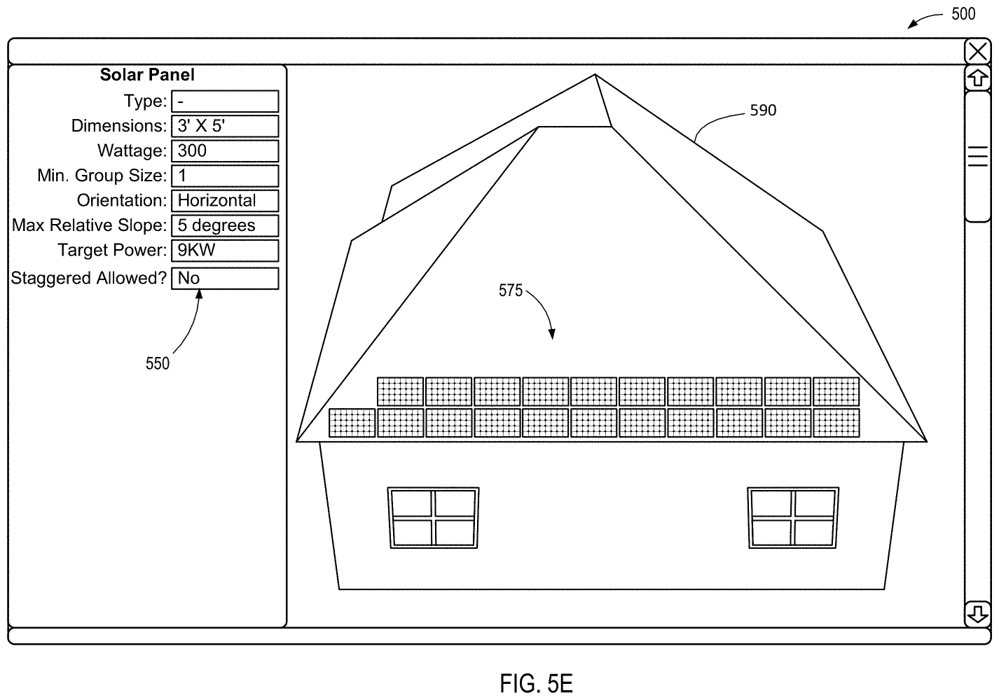

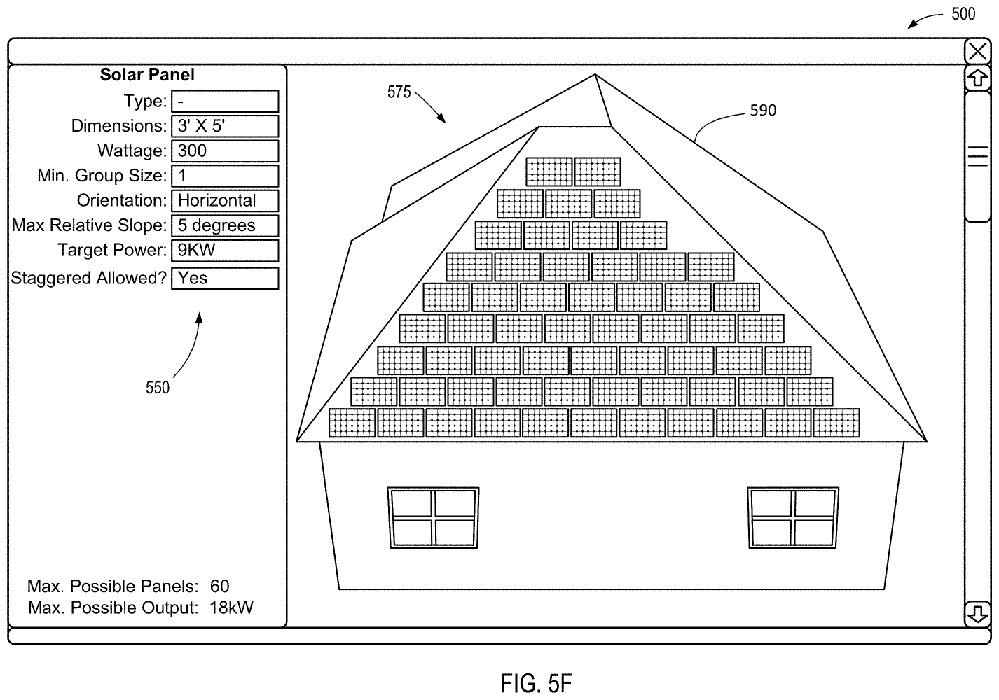

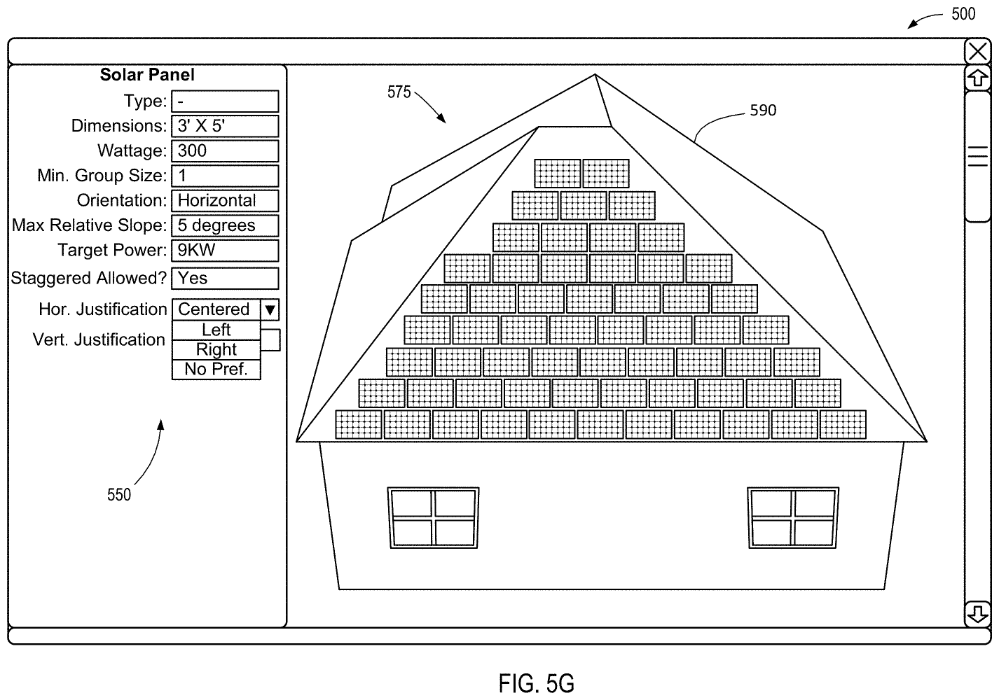

FIG. 5A illustrates an example of a graphical user interface 500 of a solar panel placement system modeling the placement of a solar panel 510 on a roof of a three-dimensional model of a structure 590, according to one embodiment. As illustrated, the solar panel placement system may initially render a single solar panel 510 when the minimum group size is specified as “1” in the specification panel 550. As shown in subsequent figures, the solar panel placement system may incrementally place additional panels on the modeled roof, shift one or more panels or groups of panels on the modeled roof, and/or otherwise manipulate the total number of panels, orientations, and relative locations of the solar panels on the modeled roof of the structure 590 to exhaustively identify all possible arrangements and configurations of solar panels on the roof.

In some embodiments, the solar panel placement system may be limited to horizontal and vertical orientations of the solar panels relative to any edge or a specific edge of the portion of the roof. In some embodiments, the solar panel placement system may utilize default minimum distances from edges of the roof to accommodate for installation hardware, errors in the three-dimensional model of the roof, and/or variations in the dimensions of each solar panel relative to the specified dimensions.

FIG. 5B illustrates the graphical user interface 500 of the solar panel placement system modeling the incremental addition of a second solar panel 511 to form an array of solar panels in a single row on the roof of the three-dimensional model of the structure 590, according to one embodiment. As illustrated, the first solar panel 510 and the second solar panel 511 are aligned with respect to one another. In some embodiments, the solar panel placement system models the placement of solar panels having differing sizes, solar panels having differing total wattages, solar panels having differing maximum power point currents (Iₘₚₚ), solar panels having differing maximum power point voltages (Vₘₚₚ), and/or combinations thereof.

In some embodiments, the solar panel placement system models connections and placements between solar panels having matching or corresponding maximum power point voltages and currents. For example, smaller panels with lower maximum power point voltages may be positionally grouped together on one portion of the roof and larger panels with larger maximum power point voltages may be positionally grouped together on a second portion of the roof. In some instances, the solar panel placement system may model some panels in a series electrical connection with respect to other panels in a parallel electrical connection.

FIG. 5C illustrates the graphical user interface 500 of the solar panel placement system determining a maximum number of solar panels that can be accommodated on a bottom row of the portion of the roof of the structure 590, according to one embodiment. Each solar panel may have been successively modeled and/or shifted until the maximum number of solar panels on the bottom row is identified. As illustrated, the group of solar panels 575 includes solar panels 510, 511, 512, 513, 514, 515, 516, 517, 518, 519, and 520. The last solar panel 521 is shown grayed out with an “X” indicating that the solar panel 521 cannot be accommodated on this portion of the roof because the edge of the solar panel extends past the edge of the portion (e.g., planar face) of the roof.

In some embodiments, the bottom row of the group of solar panels 575 may be incrementally shifted up and down to identify the number of solar panels that can be accommodated on the next row and/or to maximize the total number of solar panels that can be accommodated on the portion of the roof. Portions of roofs with curves, chimneys, odd angles, gables, windows, skylights, and the like may present more complicated scenarios that are more likely to benefit from shifting individual panels and groups of panels to the left, right, up, and/or down to identify the maximum number of panels that can be accommodated on any given surface or portion of the roof. For example, rows, columns, or groups of solar panels may be incrementally shifted up, down, left, or right to maximize the number of panels that can be accommodated given the presence of, for example, vent pipes on the roof.

FIG. 5D illustrates the graphical user interface 500 of the solar panel placement system identifying the maximum number of solar panels that can be accommodated on the penultimate row of the portion of the roof, according to one embodiment. Again, the right-most solar panel 522 on this penultimate row is shown grayed out and has an “X” indicating that the solar panel cannot be accommodated. The group of solar panels 575 includes a bottom or last row with 11 solar panels. The penultimate row only includes 10 solar panels because the right-most solar panel 522 does not fit within the planar surface of the roof of the structure 590.

In the illustrated embodiment, the left-most solar panel on each of the last row and the penultimate row of the group of solar panels 575 is shifted to the left as much as possible (e.g., within an edge tolerance threshold to, for example, accommodate mounting hardware). Alternative arrangements and positionings may be specified by the user or used by default. For instance, the solar panel placement system may align the solar panels on each row to a left edge of the planar surface of the roof, centered between left and right edges of the planar surface of the roof, or aligned within the right edge of the planar surface of the roof.

FIG. 5E illustrates the graphical user interface 500 of the solar panel placement system with a user specification in the specification panel 550 that staggering of the solar panels is not allowed. According to the user specification, the solar panels in the penultimate row of the group of solar panels 575 are shifted so that the edges of the solar panels in the two rows are vertically aligned, according to one embodiment. The “staggered allowed” specification in the specification panel 550 may be set to “yes” or “no” based on aesthetic preferences of the user and/or hardware and installation constraints of the solar panels and/or installation equipment used for modeling.

FIG. 5F illustrates the graphical user interface 500 of the solar panel placement system identifying the maximum number of solar panels that can be accommodated on the portion of the roof as determined by incremental addition of panels to each row starting from the left, according to one embodiment.

FIG. 5G illustrates the graphical user interface 500 of the solar panel placement system shifting each row of panels to the center based on a user-specified horizontal justification preference, according to one embodiment.

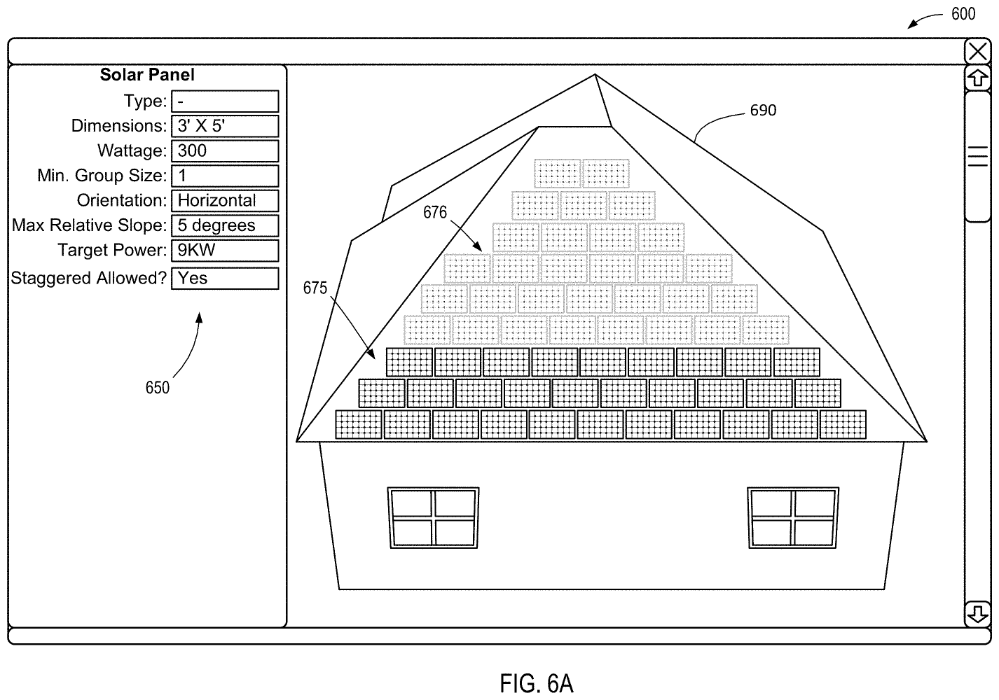

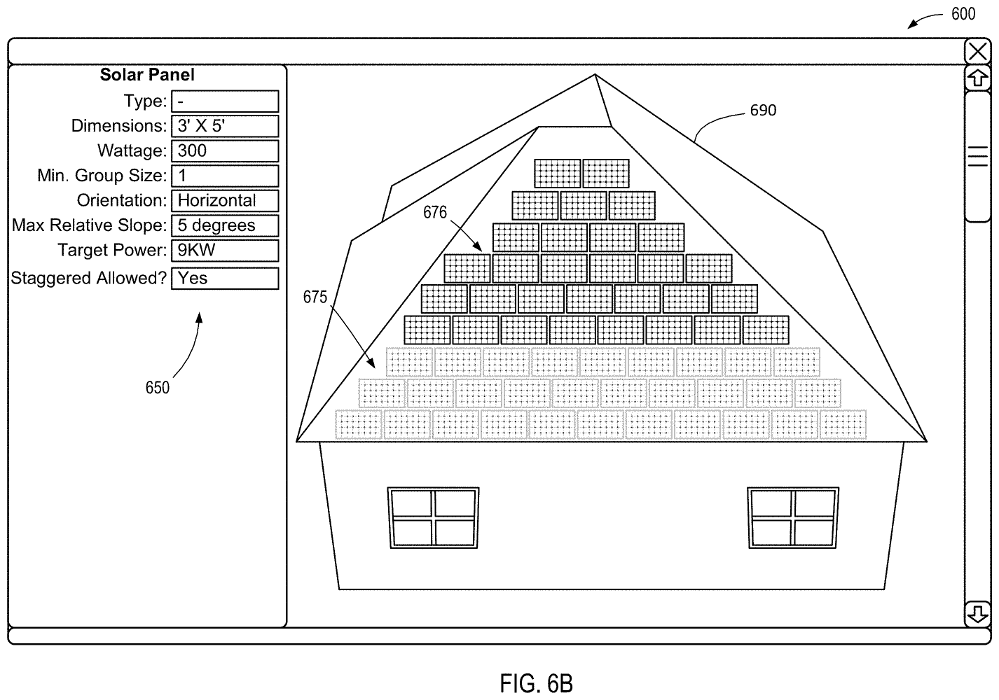

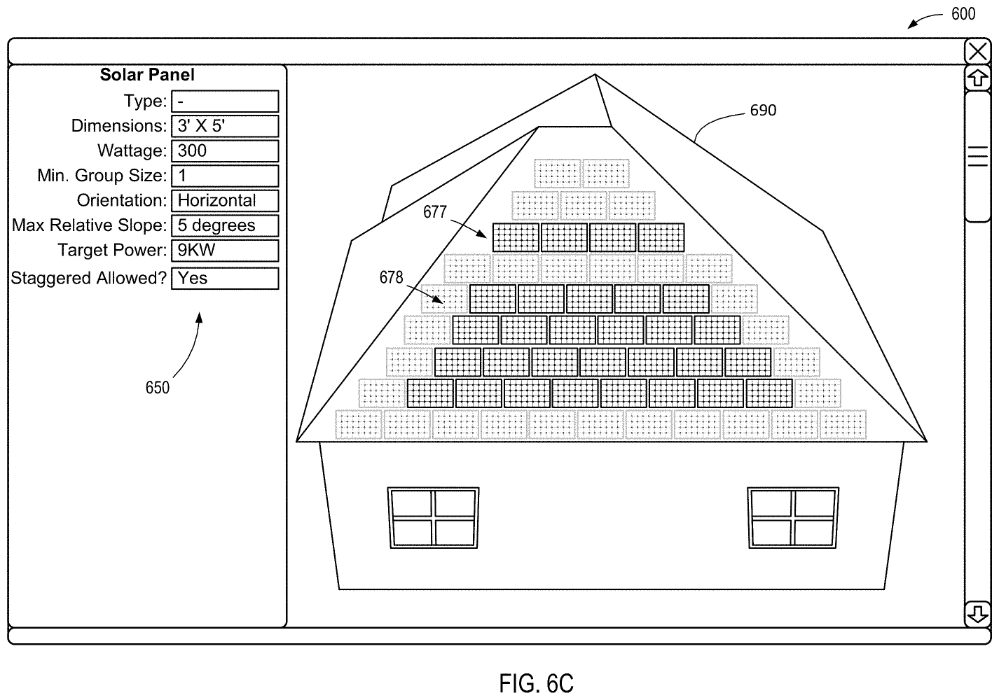

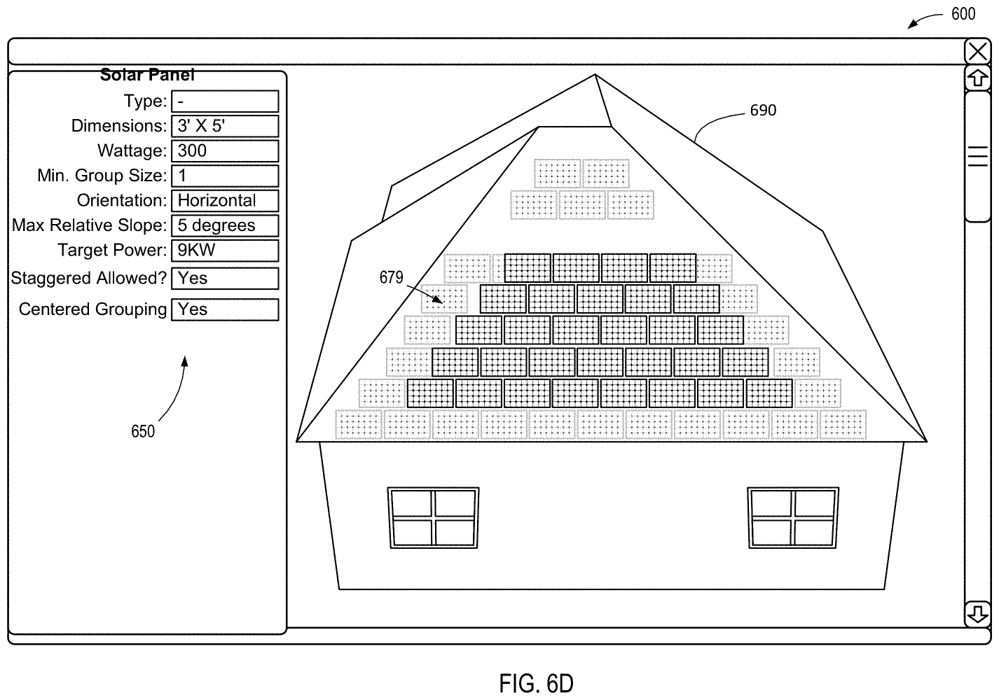

FIG. 6A illustrates a graphical user interface 600 of a solar panel placement system identifying a possible arrangement of 30 300-Watt solar panels to attain a target output power of 9 kW, according to one embodiment. As illustrated, the specification panel 650 includes options for selecting a staggered solar panel placement with a target power of 9 KW. Given the wattage rating of 300 watts for the selected 3′ by 5′ solar panels, the system determines that they need 30 panels to achieve the targe power. In the illustrated embodiment, the group of lower 30 panels 675 are selected and positioned in the staggered placement. Greyed out alternative options for placement of the solar panels 676 are shown. The target power may represent a maximum possible power output or a target real-world target power based on solar irradiance calculations and the expected performance (e.g., specifications and parameters) of the solar panels.

FIG. 6B illustrates the graphical user interface 600 of the solar panel placement system identifying an alternative arrangement of 30 300-Watt solar panels to attain a target output power of 9 kW, according to one embodiment. In the illustrated embodiment, the group of upper 30 panels 676 are selected. The lower 30 panels 675 are greyed out to show the alternative, unselected option.

FIG. 6C illustrates the graphical user interface 600 of the solar panel placement system identifying another alternative arrangement of 30 300-Watt solar panels to attain a target output power of 9 kW, according to one embodiment. In the illustrated embodiment, a selection of 30 disjointed groups of solar panels 677 and 678 are selected. In some embodiments, the system may determine if the groups 677 and 678 of solar panels can be combined or grouped together by shifting one or both groups of solar panels on the roof of the structure. The solar panel placement system may operate according to prescribed rules, such as maintaining a minimum group size, attempt to vertically align any grouping, attempt to horizontally align any grouping, or the like.

FIG. 6D illustrates the graphical user interface 600 of the solar panel placement system identifying an arrangement of 30 300-Watt solar panels 679 based on the arrangement in FIG. 6C with a centered grouping preference activated, according to one embodiment. As illustrated, the target power output is achieved with the minimum number of solar panels possible with a center grouping relative to the edges of the planar surface of the portion of the roof.

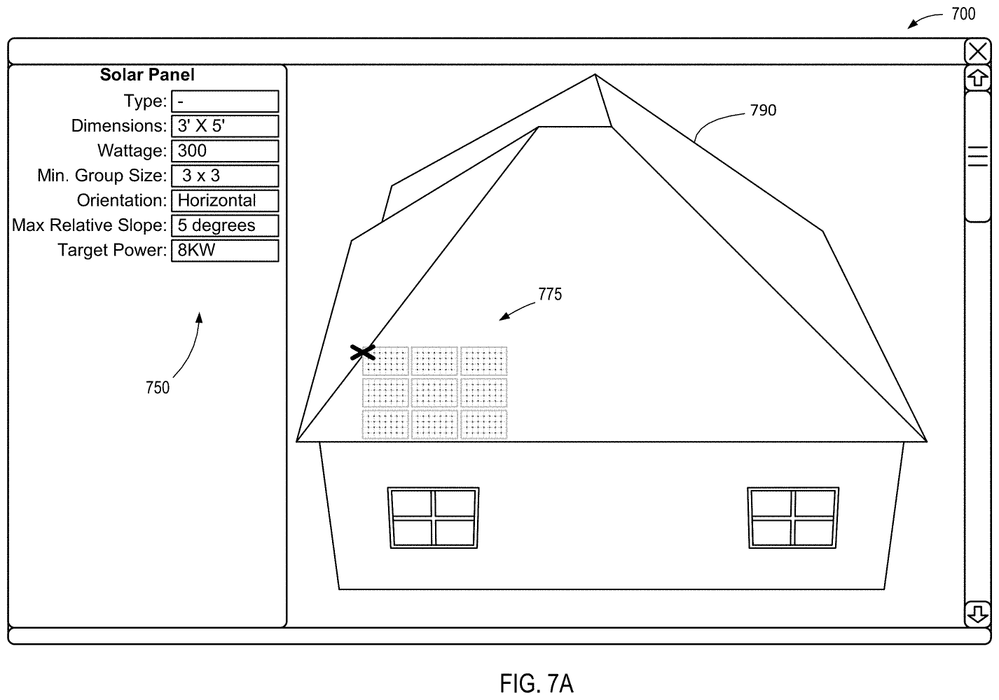

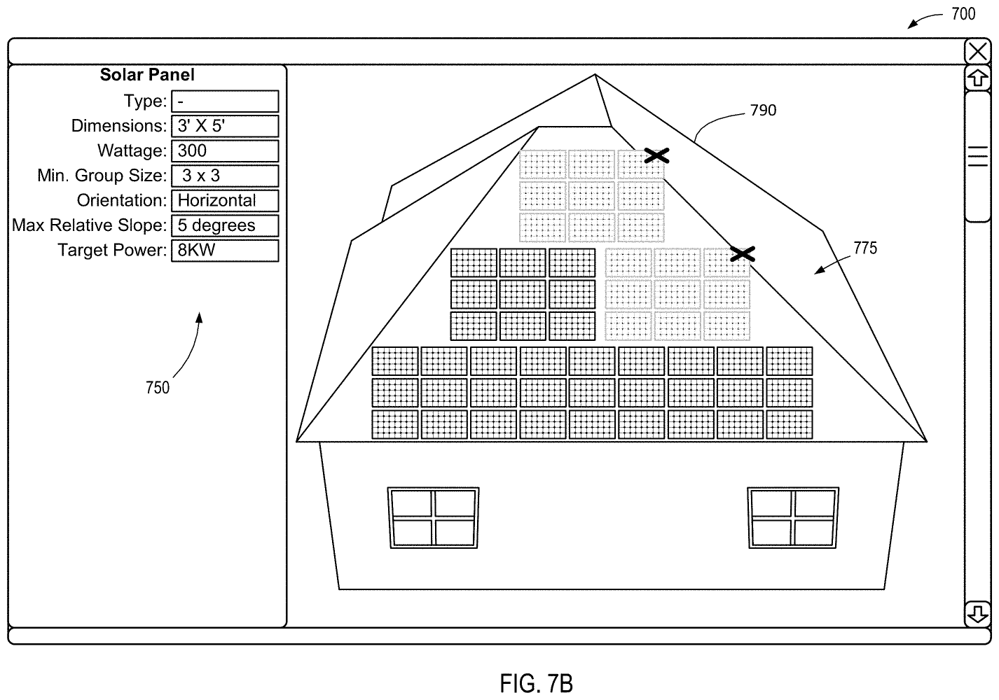

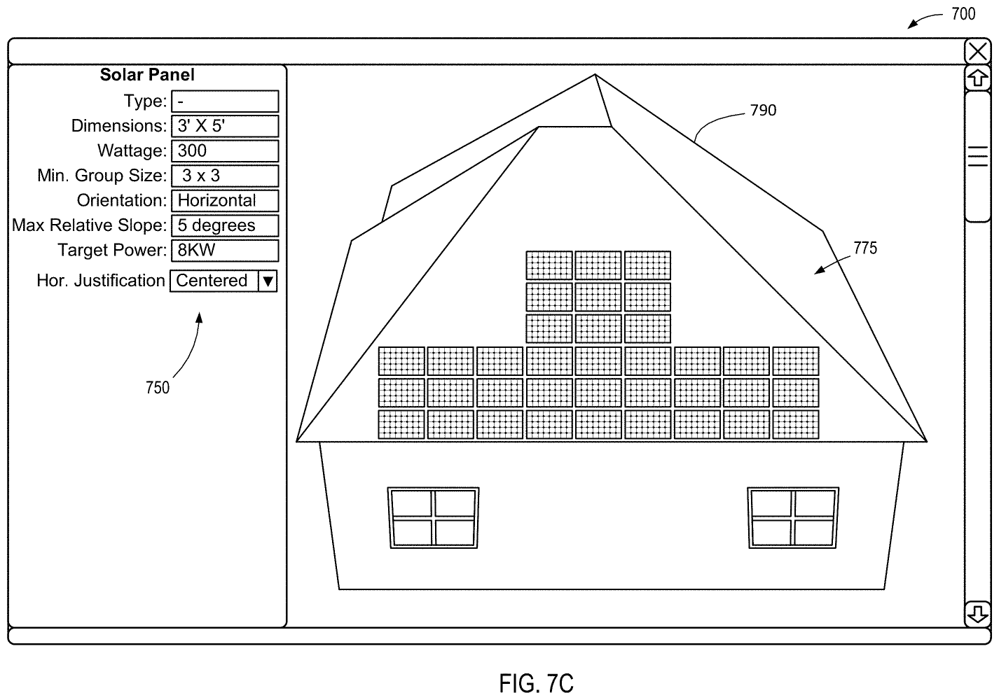

FIG. 7A illustrates a graphical user interface 700 of a solar panel placement system modeling the placement of a 3×3 solar panel group 775 on a roof of a three-dimensional model of a structure 790, according to one embodiment. As illustrated, a user has set a solar array parameter in the specification panel 750 that requires a minimum group size of 3×3. As illustrated, in the first attempted position the 3×3 solar panel group 775 does not fit within the boundaries or edges of the roof of the structure 790.

FIG. 7B illustrates the graphical user interface 700 of the solar panel placement system identifying the maximum number of 3×3 solar panel groups 775 that can fit on each row of 3×3 solar panel groups on the roof of the three-dimensional model of the structure 790, according to one embodiment. As illustrated, only four 3×3 groups 775 of solar panels fit on the roof of the structure 790. It is appreciated that the groups 775 may be shifted up, down, left, and/or right on the roof. The solar panel placement system may present one or more possible arrangements to a user via a graphical user interface based on one or more parameters provided by the user and/or otherwise configured as part of a default configuration of parameters of the solar panel placement system. The parameters may, for example, include solar panel parameters (e.g., size, brand, type, etc.), solar array parameters (e.g., target power, minimum group sizes, vertical centering, horizontal centering, etc.), and/or aesthetic parameters, as described herein.

FIG. 7C illustrates the graphical user interface 700 of the solar panel placement system shifting each row of 3×3 solar panel groups 775 based on a user-specified horizontal justification preference in the specification panel 750, according to one embodiment.

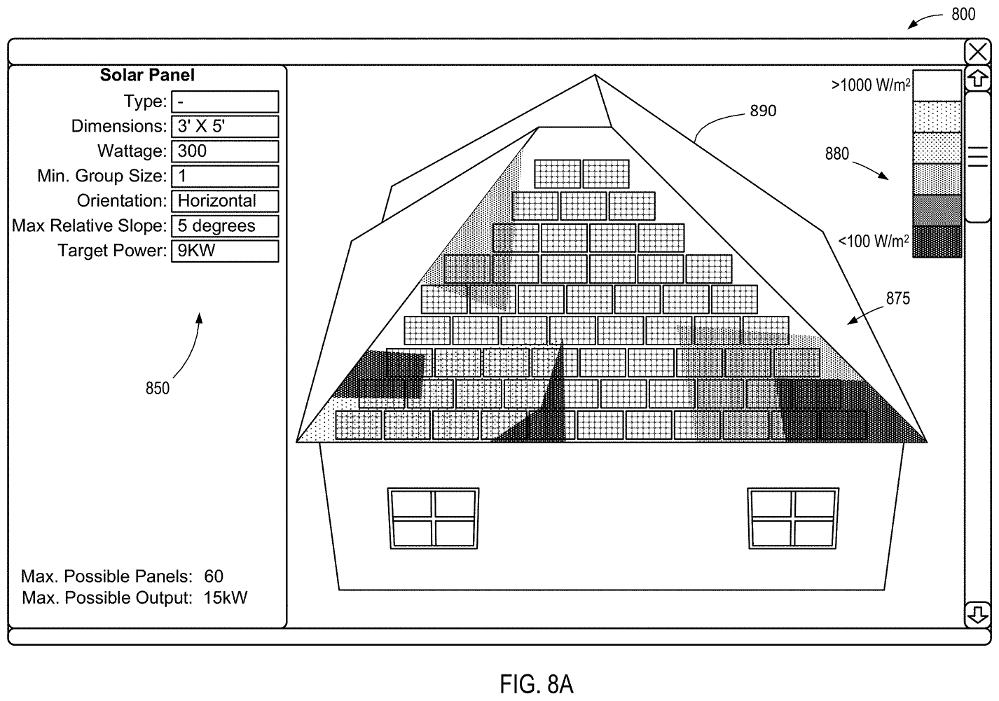

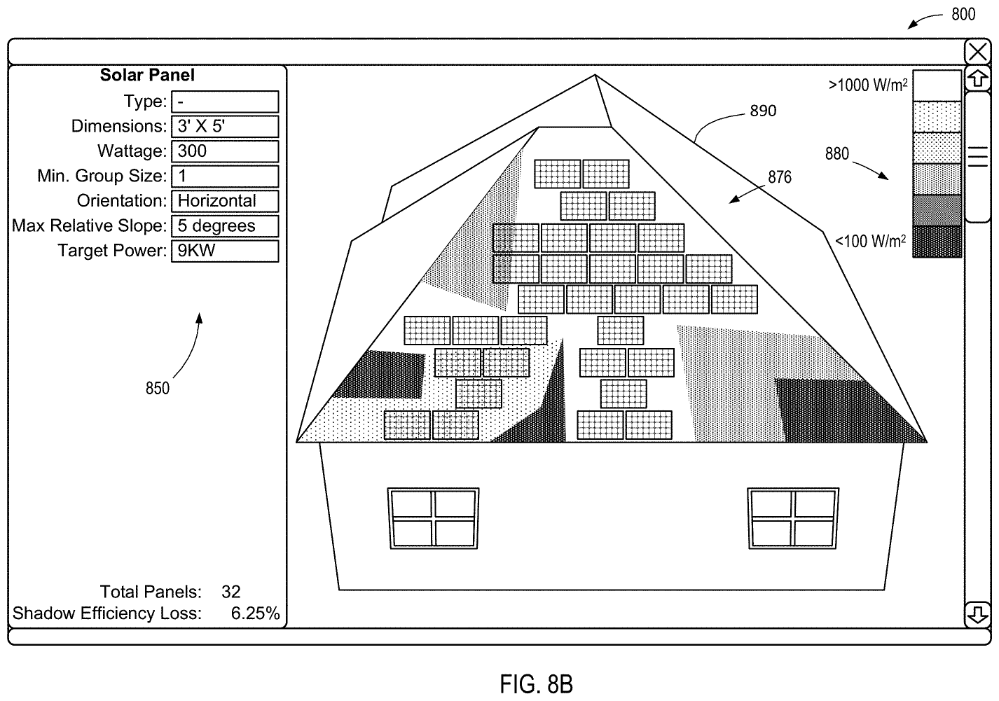

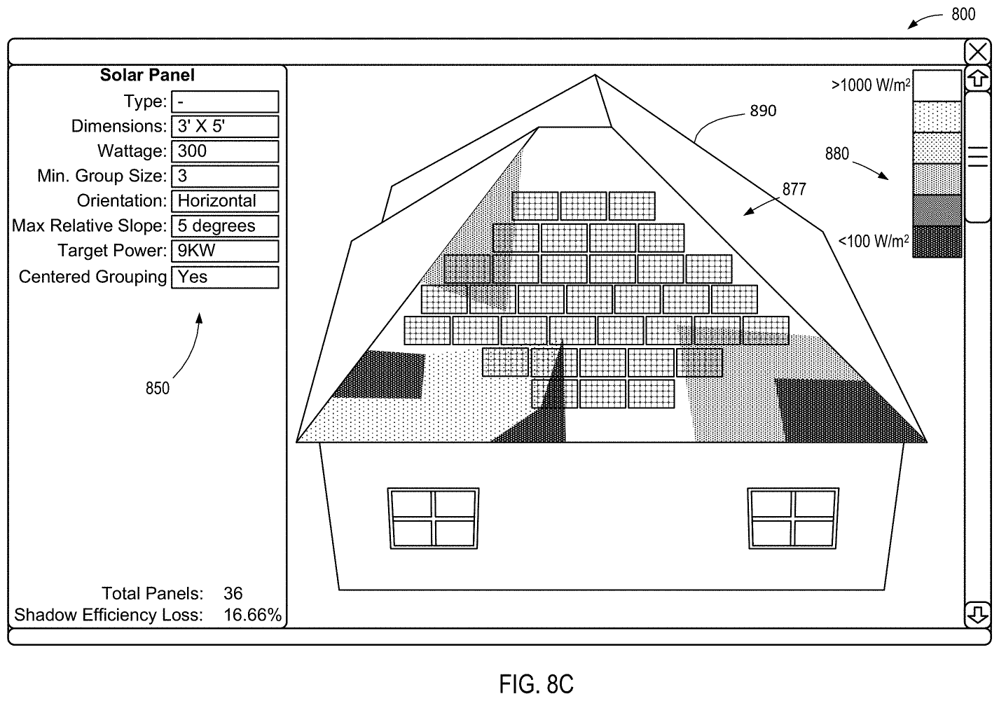

FIG. 8A illustrates an example of a graphical user interface 800 of a solar panel placement system identifying the maximum number of solar panels that can be accommodated on a roof of a structure 890 with an overlaid heatmap of solar irradiance, according to one embodiment. The graphical user interface 800 may include the overlaid heatmap identifying various levels of solar irradiance exposure during a relevant time period (e.g., a moment in time, an hour, a day, a week, a month, a number of months, a year, multiple years, etc.). In the illustrated embodiment, the graphical user interface presents the heatmap overlaid on the surface of the roof and the solar panels themselves. In some embodiments, the specification panel 750 allows the user to toggle the view to selectively show and hide the heatmap, selectively show and hide the solar panels, selectively show and hide the specific obstacles obstructing the roof that cause the shadows, etc.

A legend 880 may indicate numerical values (e.g., irradiance values) corresponding to various levels of shading. The solar panel placement system may utilize the solar irradiance values associated with each location on the roof of the structure to identify possible arrangements of solar panels 875 that will maximize the total power output or attain target parameters (e.g., total output, lowest cost per kilowatt, most kilowatts within a prescribed budget, or the like).

FIG. 8B illustrates an example of the graphical user interface 800 of the solar panel placement system identifying the most efficient locations for solar panels with a minimum group size of 1 that can be used to generate the target output power of 9 kilowatts, according to one embodiment. A resulting arrangement 876 is relatively disjointed. To attain the target output power of 9 kilowatts, some of the solar panels are placed in regions of the roof that are at least partially shadowed at times. Because some of the solar panels are shadowed at times, the 9 kilowatts are attained using 32 solar panels with a nominal total output power of 9.6 kilowatts.

FIG. 8C illustrates an example of the graphical user interface 800 of the solar panel placement system identifying the most efficient locations for solar panels with a minimum group size of 3 that can be used to generate the target output power, according to one embodiment. The added constraint results in more solar panels being positioned in shadowed regions of the roof that receive a lower total solar irradiance. Accordingly, the target power of 9 kilowatts is attained using an arrangement 877 of 36 solar panels that have a nominal output power of 10.8 kilowatts. As such, it is appreciated that conformity with some solar panel parameters, solar array parameters, and/or aesthetic parameters may result in decreased efficiency that may be acceptable to the user in favor of personal preferences, product availability, aesthetic reasons, local ordinances, laws, available rebates, or the like.

According to various embodiments, the solar panel placement system may determine a first layout to achieve a target output power based on the solar panel system parameters and irradiance calculations. In response to changes or updated system parameters (e.g., panel sizes, panel wattages, required staggering or vertical alignment parameters, efficiency metric minimums, grouping parameters, or the like), the solar panel placement system may determine a second layout for placing the panels that conforms to the various parameters.

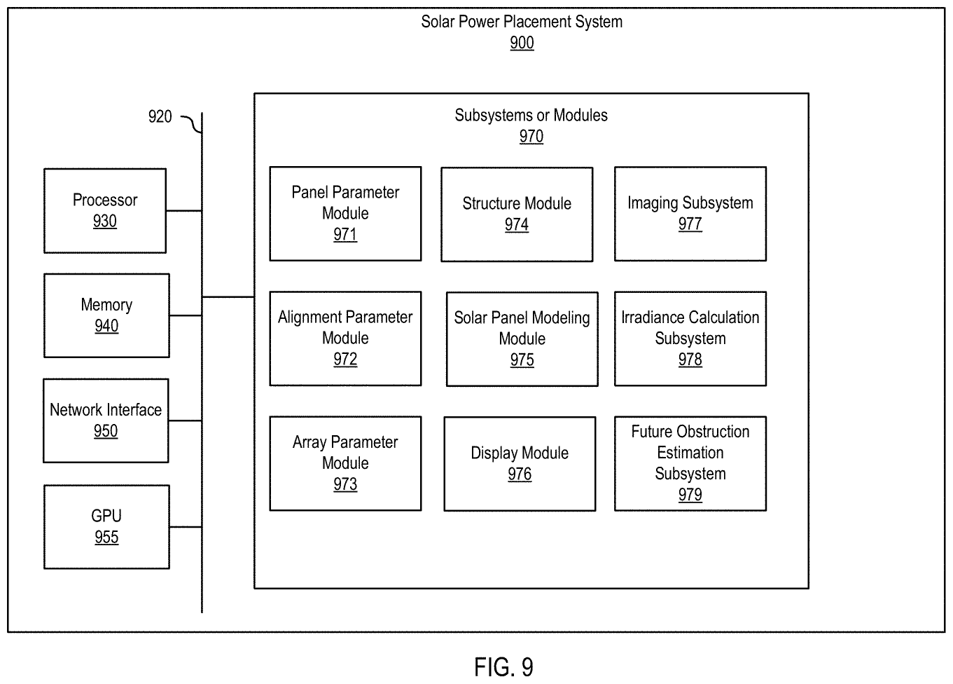

FIG. 9 illustrates a solar panel placement system 900, according to one embodiment. The solar panel placement system 900 may include a processor 930, a memory 940, a network interface 950, and a graphics processing unit 955 connected via a bus 920 to various subsystems or modules 970. For example, the solar panel placement system 900 may include various modules 970 with instructions stored therein that, when executed by the processor 930, cause the solar panel placement system 900 to implement the various operations, methods, and functions described herein. One or more of the modules 970 may be omitted in some embodiments and/or additional modules may be included in some embodiments.

A panel parameter module 971 may identify solar panel parameters, such as solar panel size parameters, by accessing a database and/or receiving a user input. An alignment parameter module 972 may identify solar panel alignment parameters, such as whether the panels in each group of panels or in the entire array of panels can be staggered or must be edge aligned for aesthetic or installation reasons.

An array parameter module 973 may identify solar panel array parameters, including, but not limited to, a minimum group size, allowed panel orientations, maximum angle relative to the roof, minimum total power, maximum total power, target total power, and the like.

A structure module 974 may retrieve a three-dimensional model of a structure with at least one planar roof surface.

A solar panel modeling module 975 may calculate positions for each of a plurality of solar panels on the planar roof surface. For example, the positions may be calculated based on the solar panel size parameters, the solar panel alignment parameters, the solar panel array parameters, and/or combinations thereof. The solar panel modeling module 975 may further render a three-dimensional model of the plurality of solar panels arranged on the planar roof surface of the three-dimensional model of the structure.

A display module 976 may render a graphical user interface for display on an electronic display, the graphical user interface including the rendered three-dimensional model of the plurality of solar panels arranged on the planar roof surface of the three-dimensional model of the structure. As described herein, the display module 976 may render a heatmap of solar irradiance values as an overlay on the planar roof surface of the structure and as an overlay on the plurality of solar panels arranged thereon.

In some embodiments, the three-dimensional model may be generated or obtained based on images captured by an imaging subsystem 977 that may include, for example, cameras mounted on a UAV or mobile device. An irradiance calculation subsystem 978 may operate according to any of the embodiments, or combinations thereof, as described in the applications incorporated herein by reference. A future obstruction estimation subsystem 979 may operate according to any of the embodiments, or combinations thereof, as described in the applications incorporated herein by reference.

This disclosure has been made with reference to various embodiments, including the best mode. However, those skilled in the art will recognize that changes and modifications may be made to the embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present invention should, therefore, be determined by the following claims:

What is claimed is:

1. A solar panel placement system, comprising:
a panel parameter module to identify solar panel parameters, including at least solar panel size parameters;
an alignment parameter module to identify solar panel alignment parameters;
an array parameter module to identify solar panel array parameters;
a structure module to retrieve a three-dimensional model of a structure with a planar roof surface;
a solar panel modeling module to:
calculate positions for each of a plurality of solar panels on the planar roof surface based on the solar panel size parameters, the solar panel alignment parameters, and the solar panel array parameters, and
render a three-dimensional model of the plurality of solar panels arranged on the planar roof surface of the three-dimensional model of the structure; and
a display module to render a graphical user interface for display on an electronic display, the graphical user interface including the rendered three-dimensional model of the plurality of solar panels arranged on the planar roof surface of the three-dimensional model of the structure.

2. The system of claim 1, wherein the panel parameter module is configured to retrieve at least one solar panel parameter from a database.

3. The system of claim 1, wherein the panel parameter module is configured to obtain at least one solar panel parameter via a user input.

4. The system of claim 1, wherein at least one of the solar panel array parameters identified by the array parameter module comprises a total power output parameter.

5. The system of claim 1, wherein the solar panel alignment parameter comprises a staggering parameter that specifies whether the solar panels are to be edge-aligned or staggered.

6. The system of claim 1, further comprising:
an irradiance calculation subsystem to calculate a solar irradiance value for each location on the planar roof surface of the structure.

7. The system of claim 6, wherein at least one of the solar panel array parameters identified by the array parameter module comprises a total power output parameter.

8. The system of claim 7, wherein the solar panel modeling module is configured to calculate the positions of the plurality of solar panels to include a minimum number of solar panels to satisfy the total power output parameter during a defined time period based on the calculated solar irradiance values.

9. The system of claim 8, wherein the display module is further configured to render a heatmap of solar irradiance values as an overlay on the planar roof surface of the structure and as an overlay on the plurality of solar panels arranged thereon.

10. The system of claim 7, wherein the solar panel alignment parameters include a minimum group size parameter defining a minimum number of solar panels to be included in a subgroup of the plurality of solar panels on the planar roof surface.

11. The system of claim 10, wherein the solar panel modeling module is configured to calculate the positions of the plurality of solar panels to include a minimum number of solar panels to satisfy the total power output parameter during a defined time period based on the calculated solar irradiance values, without violating the minimum group size parameter.

12. The system of claim 11, wherein the display module is further configured to render a heatmap of solar irradiance values as an overlay on the planar roof surface of the structure and as an overlay on the plurality of solar panels arranged thereon.

13. A non-transitory computer-readable medium with instructions stored thereon that, when executed by a processor of a computing device, cause the computing device to perform operations to:
identify solar panel parameters, including at least solar panel size parameters;
identify solar panel alignment parameters;
identify solar panel array parameters;
retrieve a three-dimensional model of a structure with a planar roof surface;
calculate positions for each of a plurality of solar panels on the planar roof surface based on the solar panel size parameters, the solar panel alignment parameters, and the solar panel array parameters;
render a three-dimensional model of the plurality of solar panels arranged on the planar roof surface of the three-dimensional model of the structure; and
render a graphical user interface for display on an electronic display, the graphical user interface including the rendered three-dimensional model of the plurality of solar panels arranged on the planar roof surface of the three-dimensional model of the structure.

14. The non-transitory computer-readable medium of claim 13, wherein at least one of the solar panel array parameters comprises a total power output parameter.

15. The non-transitory computer-readable medium of claim 13, wherein the solar panel alignment parameter comprises a staggering parameter that specifies whether the solar panels are to be edge-aligned or staggered.

16. The non-transitory computer-readable medium of claim 13, wherein the instructions, when executed by a processor of a computing device, further cause the computing device to:
calculate a solar irradiance value for each location on the planar roof surface of the structure.

17. The non-transitory computer-readable medium of claim 16, wherein at least one of the solar panel array parameters comprises a total power output parameter.

18. The non-transitory computer-readable medium of claim 17, wherein the instructions, when executed by a processor of a computing device, cause the computing device to calculate the positions of the plurality of solar panels to include a minimum number of solar panels to satisfy the total power output parameter during a defined time period based on the calculated solar irradiance values.

19. The non-transitory computer-readable medium of claim 18, wherein the instructions, when executed by a processor of a computing device, further cause the computing device to:
render a heatmap of solar irradiance values as an overlay on the planar roof surface of the structure and as an overlay on the plurality of solar panels arranged thereon.

20. A method, comprising:
accessing an electronic database to retrieve solar panel parameters, including at least solar panel size parameters;
receiving, via an electronic input device of a computer, an input from a user specifying solar panel alignment parameters;
determining solar panel array parameters;
receiving a three-dimensional model of a structure with a planar roof surface;
calculating positions for each of a plurality of solar panels on the planar roof surface based on the solar panel size parameters, the solar panel alignment parameters, and the solar panel array parameters;
rendering a three-dimensional model of the plurality of solar panels arranged on the planar roof surface of the structure; and
rendering a graphical user interface for display on an electronic display, the graphical user interface including the rendered three-dimensional model of the plurality of solar panels arranged on the planar roof surface of the structure.
